(19) United States
(12) Patent Application Publication
(10) Pub. No.: US 2021/0112359 A1
(43) Pub. Date: Apr. 15, 2021

(54) SYSTEM AND METHOD FOR POINT-TO-POINT COMMUNICATION IN A SHARED ENVIRONMENT

(71) Applicants: Mark PRICE, Solana Beach, CA (US); Todd WANKE, Palos Verdes Estates, CA (US)

(72) Inventors: Mark PRICE, Solana Beach, CA (US); Todd WANKE, Palos Verdes Estates, CA (US)

(21) Appl. No.: 17/030,303

(22) Filed: Sep. 23, 2020

Related U.S. Application Data
(60) Provisional application No. 62/904,488, filed on Sep. 23, 2019.

(51) Int. Cl. H04S 7/00; H04W 68/00

(52) U.S. Cl. CPC H04S 7/302; H04W 68/005

(57) ABSTRACT

A system, method and computer product for point to point communication within a shared environment. A process includes receiving an address from a first person to a second person, the second person using a computing system that provides at least limited aural or visual isolation for the second person within a shared environment. The process further incudes determining an identity of the second person from a datastore according to the address from the first person, the identity being associated with a computing system used by the second person. The process further includes generating a notification for the second person based on determining the identity, the notification comprising an electronic signal that is transmittable via a communication network to the computing device associated with the second person.

### CROSS REFERENCE TO RELATED APPLICATIONS

The present application claims priority from U.S. Provisional Patent Application No. 62/904,488, filed Sep. 23, 2019, entitled “SYSTEM AND METHOD FOR POINT-TO-POINT COMMUNICATION IN A SHARED ENVIRONMENT”, the disclosure of which is incorporated herein by reference in its entirety.

### TECHNICAL FIELD

The subject matter described herein relates to a shared environment, and more particularly to a system and method for point-to-point communication in a shared environment of multiple occupants, including users of headphones.

### BACKGROUND

Conventionally, it is very common for two or more people to share a common space, i.e. a “shared environment,” whether for work or otherwise, but especially in a workplace. The shared environment can include a single enclosed space, or a number of different spaces that are physically interconnected, or connected by a communication network. People who work or live in conventional shared environments often use a computing device while in the shared environment, such as a desktop or laptop computer, or a tablet or handheld computing device such as a smartphone.

Often, people in a shared environment use headphones to isolate themselves from others in the shared environment. The term “headphones,” as used herein, includes headphones, earbuds, or any set or pair of small speaker drivers worn on, over, or in a user's ears, and are sometimes also referred to as earphones, airbuds or airpods. Headphones include electroacoustic transducers, which convert an electrical signal to a corresponding sound. Headphones allow a single user to privately listen to audio from an audio source, in contrast to a loudspeaker, which emits sound into the open air for anyone nearby to hear. Audio can include music and/or voice, or other sounds. While such private listening or isolation can allow a user to avoid distractions and improve productivity for themselves, particularly in a shared environment or common space with other users, the isolation can impede communication and collaboration with other persons in the shared environment.

While working and/or living in a shared environment, and while interacting with a computing device to use any of the many applications provided by the computing device, including one of many audio-playing applications, what is needed is a system and method to enable addressing or getting a targeted person's attention, without addressing or distracting non-targeted persons.

### SUMMARY

This document presents systems and methods that can enable addressing or getting a targeted person's attention, without addressing or distracting non-targeted persons, within a shared environment.

In some implementations, a system, method, and computer program product includes execution of a process that includes the steps of receiving an address from a first person to a second person within a shared environment. The process further includes determining an identity of the second person from a datastore according to the address from the first person, the identity being associated with a computing system used by the second person. The process further includes generating a notification for the second person based on determining the identity, the notification comprising an electronic signal that is transmittable via a communication network to the computing device associated with the second person.

In some variations, the second person can be using headphones that produce sound to provide at least limited aural isolation for the second person within a shared environment, and the electronic signal of the notification can be used to control a sound from the headphones.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an system and method for point-to-point communication in a shared environment, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a shared environment, such as an open-spaced, shared-work environment, in which a first person can verbally address a selected one of a number of second persons within the shared environment;

FIG. 2 depicts a shared environment occupied by two or more persons, where at least one or more of the two or more persons is using headphones; and

FIG. 3 is a flowchart of a method for point-to-point communication in a shared environment; and

FIG. 4 illustrates an application display that generates a graphical user interface (GUI) for an application configured to enable point-to-point communication in a shared environment.

When practical, similar reference numbers denote similar structures, features, or elements

### DETAILED DESCRIPTION

This document describes a system and method configured for allowing a first person to address a targeted second person within a shared environment, without addressing or distracting non-targeted other persons within the shared environment. In some implementations, the address can be communicated from the first person to the second person via a service provided by an application or a plug-in that is employed by respective computing devices used by the first, second persons, and the other persons. In these cases, the application or plug-in can provide a list or grouping of addressable second persons. The list or grouping can be limited to a particular number of persons, such as a number of persons each other person interacts with on a regular basis.

Such list or grouping can be based on a group, an organization, or a hierarchy to which all the persons are affiliated or associated. Each of the first, second, and other persons can subscribe, opt-in, or participate in the service by virtue of being associated with such group, organization or hierarchy, and such subscription, opt-in, or participation can be configured through the application. For example, each person can register themselves as a user of the application or plug-in, and the application or plug-in can then allow each user to assemble a list of preferred contact persons within an organization or group of people within the shared environment.

The application and system can be segmented by tenant of the backend architecture. In some implementations for instance, to join a company tenant, a user can input an identifier, such as their email address, cell phone number, and/or other identifier or code, and the application will generate and send, via email or text, a code, such as a 5-digit code, for the user to input into the application, which joins the user to company tenant. This technique is also called tenant-friending, whereby a user can input other users' identifiers to invite other users to join the company tenant.

In some alternative implementations, a first person can aurally (i.e. verbally or by sending an audio signal) address a second person, where the aural address is a name, a key word, a unique sound, or other predetermined audio address, and where the second person is a wearer of headphones in a shared environment, such that sounds from the headphones of the second person are attenuated, or some other sound signal is provided, to represent or indicate the verbal address by the first person. In accordance with systems and methods described herein, the verbal address from the first person to the second person does not affect the use of headphones of other persons within the shared environment.

In some implementations, a headphone device or set is configured with a microphone in communication or connected with a processor. The microphone is configured to receive sounds from sources external to the headphones or its audio source (i.e. a computer, media player, a smartphone, an audio application executed by a processor, etc.) and send those sounds to the processor. The processor, in turn, is configured to receive a particular, predetermined verbal address, such as a name, an identifier, a unique signal or sound, or the like. Thus, the processor can include a filter and/or artificial intelligence (AI) module to isolate the particular verbal address from other sounds, so as to control the sound produced by the headphones to the wearer: i.e., the processor can control the headphones to attenuate the sound it produces, or can generate a different unique sound or signal to represent or indicate the verbal address. For example, the processor can weave the unique aural or audio signal into the sound of the headphones, such unique aural or audio signal to indicate to the wearer that the wearer is being addressed by another person. If the particular, predetermined verbal address is not part of, or detected from, the sounds from the external sources, it will function as normal to produce audio from the audio source.

Alternatively, a system and method as generally described above can be implemented as an application, a part of an operating system, or as a plug-in to or component of an application or operating system, and which is executed by a computer processor of a computing device. An operating system is the software that supports a computer's basic functions, such as scheduling tasks, executing applications such as standalone applications and plug-ins, and controlling peripherals, such as a mouse, a keyboard, a number pad, a touchpad, or the like.

For example, in an implementation as a plug-in, which is a software component that adds a specific feature to an existing computer program (such as an application or an operating system), the plug-in can be configured to control the headphones of any wearer who is using a computer program, such as an application or the operating system of a computer or computing device that contains the computer processor, and the control can include receiving, by the plug-in, computer program, or headphones, an address by a first person to a second person who is the wearer of the headphones.

The address can include a particular, predetermined verbal address, such as a name, an identifier, a unique signal or sound, or the like, or an electronic signal based on inputs to an input device associated with the application or operating system, such as one or more keystrokes of a keyboard, input clicks of a mouse or any other input device, whether integrate with the computing device or peripheral to the computing device, or the like. The keystrokes can also be implemented in software and generated by the plug-in and displayed within or by the application or operating system on a display associated with a computing device.

The plug-in can have an interface with both a microphone associated with the computing device, as well as an interface connected with the headphones of each of the wearers who are using an application or the operating system. The interfaces can be defined according to an application programming interface (API), which defines a set of functions and procedures allowing the creation of applications or plug-ins to those applications, and that access the features or data of an operating system, application, or other service of the computing device. The plug-in can receive the address from a first person to a second person, where the second person can be among one or more second persons in a shared environment. Upon receipt, the plug-in can access a datastore to map the address to the desired second person. Once so mapped, the second person can be accessed via a unique identifier that is used by the plug-in, and a signal can be generated by the plug-in to be sent, via a communication network and via a cloud computing infrastructure, to the computing device of the second person. Once received by the computing device of the second person, a plug-in controls a sound-generating application for the headphones of the second person, to quickly attenuate the sound of the headphones based on signals sent to the headphones from communication module, which can communicate according to any wired or wireless protocol, such as Bluetooth® or the like.

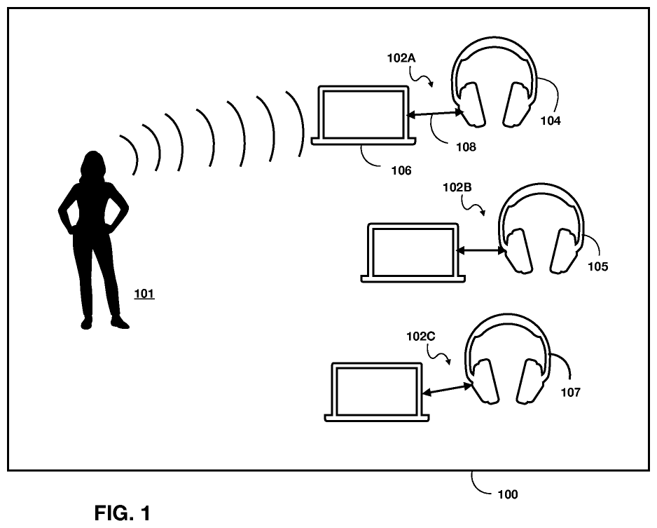

FIG. 1 depicts a shared environment 100, such as an open-spaced, shared-work environment, in which a first person 101 can verbally address a selected one of a number of second persons 102 within the shared environment 100, where at least the selected second person is wearing headphones 104, 105 and 107, which can include ear-covering headphones, earbuds, or the like, and which are sometimes also referred to as earphones, airbuds or airpods (collectively referred to herein as “headphones”). In some implementations, each of the second persons 102 may be wearing headphones 104, 105, and 107, which may be worn for the purposes of audio or sound isolation within the shared environment 100 or common work space. The first person 101 may or may not be using headphones or some other sound-communicating device, such as a microphone, etc., and may or may not be using a computing device to communicate with the sound-communicating device.

In some exemplary implementations, one or more of the second persons 102A, 102B and 102C are using a computing device 106, such as a laptop computer, desktop computer, tablet computer, smartphone, digital music player, or the like. The computing device 106 can be a source of audio for the headphones 104, 105, 107, to provide the second persons 102A with audio isolation within the shared environment 100. The headphones 104, 105 and 107 can receive audio signals, such as digital representations of audio, whether it is originally encoded as digital audio or analog audio, via communication link 108. The communication link 108 can be the same for each of the headphones 104, 105, 107, or different, and can be one or more of a wireless communication link including Bluetooth®, WiFi, or other low power wireless communication protocol, or can be a wired connection between the computing device 106 and the associated headphones.

In accordance with some implementations, the first person 101 wants to gain the attention of one of the second persons 102A, who is using headphones 104, while not bothering other second persons 102B, 102C (or third, fourth, etc. other persons) wearing headphones 105 and 107, or interfering with such other second persons' 102B, 102C use of their headphones 105 and 107. The associated computing device 106, the headphones 104, and/or a listening module associated with communication link 108 can include a microphone or other listening device or module. In some implementations, a verbal or other sound address by the first person 101 to the second person associated with headphones 104 causes the headphones 104 to modify its operation (turn off, attenuate any sound produced thereby, or communicate an address signal, or the like, such as generate a sound to be produced in the headphones 104), while allowing headphones 105, 107 to continue with normal operation.

The verbal address can include a keyword, such as a particular name or other distinctive audio or sound. The computing device 106, the headphones 104, and/or the listening module associated with the communication link 108 can be pre-programmed or pre-set with the verbal or other sound address. For instance, if the first person 101 states the name of second person 102A, then the associated computing device 106, the headphones 104, and/or a listening module associated with communication link 108 can trigger a change in operation of the headphones 104, such as attenuating an sound produced thereby, while leaving all other headphones 105, 107 in the shared environment 100 unaffected or unchanged.

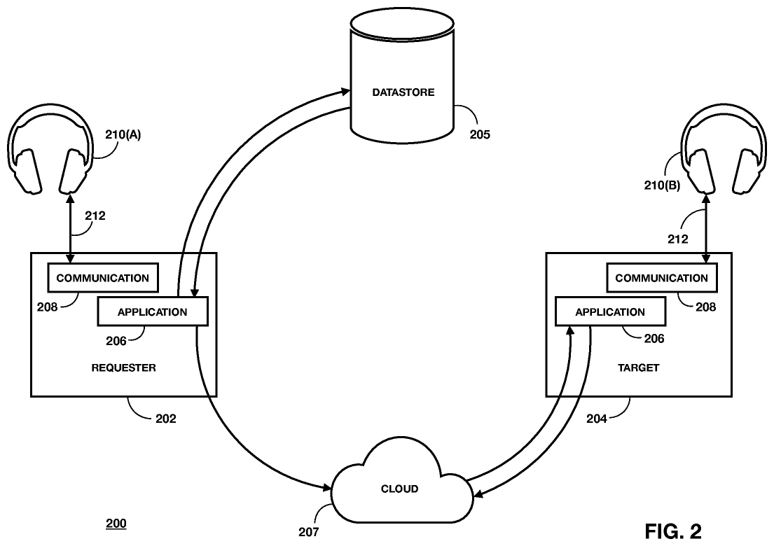

FIG. 2 depicts a shared environment 200 occupied by two or more persons, where at least one or more of the two or more persons is using headphones, earbuds, or the like, which are sometimes also referred to as earphones, airbuds or airpods (collectively, “headphones 210”). The shared environment 200 can be a room that is enclosed by one or more interior walls, or a building defined by external walls. The room defining the shared environment 200 can be configured as an “open workspace” environment, which can include multiple workspaces for multiple persons within a common work area.

A person uses the headphones to have sound isolation in the shared environment 200, whereby the headphones provide sounds such as music or noise-cancellation signals, or both, or voice signals from a telephony communication, only to the person's ears in an isolated fashion, and which headphones often physically or electronically isolate the person's ears from external sounds. FIG. 2 illustrates a system and method for a first person (“requester”) to address and communicate with a second person (“target”), where at least the second person is using headphones within the shared environment 200, so as to alert the second person of the address, and/or attenuate sound from the target's headphones sufficient to enable the communication upon being addressed, while not disturbing any other non-addressed persons nor controlling their headphones.

The headphones 210 can be receive audio signals from an audio communication module 208, which can be any combination of hardware, software or firmware, and configured to generate an audio signal for the headphones 210, either via a wired or wireless connection 212 from the audio communication module 208. The audio communication module 208 can include, without limitation, an audio output jack for a wired connection to the headphones 210, or an audio transmitter or transceiver for a wireless connection to the headphones 210, such as a short-distance, ultra-high frequency radio transmitter technology and standard, such as a Bluetooth® or WIFI, or the like. The audio communication module 208 can further include audio or signal processors for generating the audio.

The audio communication module 208 can be integrated with, or part of, a requester computing device 202 and/or target computing device 204. Computing devices 202, 204 can be any of a mobile device, laptop computer, desktop computer, media player device, stereo equipment, or the like, and may include other modules such as a graphical user interface (GUI), display, data processor(s) such as image or audio processors, memory or other data storage, or other modules. The computing devices 202, 204, and other computing devices within and/or outside the shared environment 200 can be interconnected via a communication network, such as via a number of server computers, telephony equipment, wireless transceivers, or the like, collectively referred to herein as the “cloud” 207. The cloud 207 can further include one or more server computers or other computing devices to receive, process, store and/or serve data from and to the computing devices 202, 204 as requested by users of the computing devices 202, 204.

Each of the computing devices 202, 204 can be configured with computer-implemented logic to execute a method for addressing and communicating with a selected person within the shared environment 200. In some implementations, the computer-implemented logic can include an application 206 that is executed by one or more processors of the computing devices 202, 204 and/or on the headphones 210. Each application 206 can be implemented as a standalone application, or as a plug-in or agent to another application or as a plug-in to an operating system that runs the computing devices 202 or 204, or any combination thereof. For instance, the applications 206 can be a plug-in or agent to an operating system that runs various other applications, such as word processing applications, spreadsheet applications, and/or even media playing applications, such as a music player or the like.

Each application 206 can include or execute machine learning (ML) or artificial intelligence (AI) algorithms, especially for receiving audible addresses, parsing the address, and determining a content or meaning of the address. For example, if a first person verbally calls out a target second person within a shared working environment, the application 206 can receive the audible call-out, and using ML and/or AI, which can be executed by, or distributed among applications 206 and/or computing systems 202, 204, can determine a specific identifier or identifying information of the target second person.

The system further includes a datastore 205 or repository for storing information about persons or users of the system, such as any of a Global Address List, cell phone numbers associated with each user, names, user IDs, or the like. The information can be stored in the datastore 205 as encrypted information for security. Where a user's name is used or inputted into the application 206, one or more of the occupants of the shared environment 200 can register their names or other identifying information with the datastore 205.

In exemplary implementations, if the first person randomly and indiscriminately shouts a name “Scott,” and a second person named Scott has registered his name in the datastore 205 via the application 206 or other means, then the application 206, either on the requester's computing system 202 or the recipient's computing system 204, can receive the verbalized indication of “Scott” in order to poll the datastore 205 for a user associated with “Scott.” Once determined that there is a user named “Scott,” the system 200 can initiate a process to attenuate, stop, or mute any sound coming out of the headphones 210(B) associated with the second user “Scott.”

In accordance with some preferred implementations, a system that allows a requester to addressing and communicating with a selected person (i.e. a target) within the shared environment 200 can operate as follows. As depicted in FIG. 2, a first person associated with requester computing device 202 and/or headphones 210A wants to get the attention of a second person associated with a target computing device 204 and headphones 210B. In some implementations, at least the second person may be wearing headphones 210B, for playing music, and/or isolating themselves from other sound or other persons within the shared environment 200, which can host two or more persons.

The first person can indicate his or her desire to communicate with the second person by any of several processes. In some implementations, the application 206 running on the requester computing system 202 can execute a process to receive from the first person an indication of his or her desire to address, communicate with, or trigger the playing of audio to, the second person. The indication received can be the first person verbalizing the second person's name or other identifying information, which can be received by a microphone associated with gear worn by the first person, or with the requester computing system 202. In some implementations, the indication can be received by a microphone associated with the second person, or with the target computing device 204. In yet other implementations, the indication delivered by the first person can be received by any or all of second persons in the shared work environment, such that at least one of the second persons (or a computing system associated with the at least one of the second persons) receives the indication. Once received, the application 206 can start to process the indication.

In some implementations, the first person can input or indicate the name, or other identifying information, of the second person into the application 206 running on the requester computing system 202, either via input device such as a keyboard or keypad, or by a microphone, which may be associated with headphones 210A that are connected with the application 206 via communication module 208 as connected to headphones 210A by communication link 212.

In accordance with implementations of a method, the first person and one or more of the second persons can be running an agent, plug-in, extension, application or applet 206 on respective associated computing systems 202, 204, as shown in FIG. 2. The agent can be a plug-in, an applet, or other code that can be inserted into, integrated with, or otherwise interfaced with code of an operating system or one or more applications of the computing systems 202, 204. For example, the system 200 can utilize one or more application programming interfaces (APIs) that can communicate data and information between software modules that make up the communication modules 208, applications 206 or other software modules running on computing systems 202, 204.

In accordance with the methods disclosed herein, both the first person and the second person(s) can be using a computing system 202, 204 that runs the agent or application 206 that enables the functionality described herein. In some implementations, when a first person indicates or addresses a target second person, a headphone, microphone, or computing system associated with the first person and/or target second person receives the indication or address, which then processes the indication or address to generate a request, prompt, lookup, or the like, to the datastore 205 or repository in order to determine the identity of the target second person. The target second person can be identified by name, user ID, or other unique identifier, indicator or address. In some implementations, the first person and/or second person(s) can be represented in a Global Address List (GAL), such as in an email or other electronic messaging platform or service. The indication or address can be verbal, from the first person toward a desired second person, within or proximate to the shared environment, or via digital communication such as a messaging or electronic mail application. The digital communication can be integrated with the agent or software that enables the functionality described herein.

The agent or software on the target second person's computing system 204 can be configured to recognize at least some of the information communicated by the first person (i.e. name, nickname, etc.) in the address or indication, and perform a look-up of the desired target second person(s). In some implementations, the agent or software can parse the address into various words or terms, so as to determine an identifier of the target second person. For instance, if the address is “Mark, will you please come here,” the agent can receive that address, and using natural language processing, determine the terms in the address, and then using artificial intelligence, determine the second person based on the identifier “Mark.”

The lookup of the target second person can be done by application 206 on the requester first person's computing system 202, or by the application 206 on the target second person's computing system 204. The lookup can be done through the cloud 207 or directly to the datastore 205, which includes a database of the identifier information for each person registered in the system.

Once the target second person is identified by the system 200, a notification for the second person can be generated, based on determining the identity of the second person. The notification can include an electronic signal that is transmittable via a communication network, which can include the cloud 207, to a computing device associated with the second person, such as computing system 204. The electronic signal of the notification can include an instruction for modifying the sound generated by the headphones 210(B) of the second person, after the identity of the second person is determined, so as to inhibit the at least limited aural isolation by the headphones within the shared environment.

In some implementations, the instruction for modifying can include an instruction for attenuating the sound generated by the headphones 210(B). The electronic signal of the notification can further include an instruction for generating an alert on the computing device 204 associated with the second person. The alert can be a graphic or text that is generated for rendering in a display that is part of the computing device 204. The alert can also be a signal, such as an audible sound or chime, that is generated by a computing device to alert the second person of the address. In some instances, the alert can include a graphical representation of the address, as generated by the computing device.

Alternatively, where the address includes a verbal address by the first person that is received by a microphone associated with the headphones of the second person, a processor associated with the microphone can receive the verbal address, perform a natural language process (NLP) on the verbal address to determine content of the address, and then perform an artificial intelligence (AI) algorithm on the content of the address to determine the second person addressee.

The artificial intelligence algorithm can include, without limitation, a lookup in a database on a datastore of an identity of the second person. For example, determining the identity of the second person can further include executing a NLP algorithm on the address received by the microphone to determine an identifier associated with the second person, and performing a lookup on the datastore based on the identifier to determine the identity of the second person. The AI algorithm can be executed to determine a context of the address, such as, for example and without limitation, an urgency and/or a reason for the address, or type of response to that address that is being sought by the first person.

The urgency and/or reason for the address may also be indicated if the first person uses a drop-down list on a display of their computing device of possible second persons. For instance, the first person may select from a predetermined list of reasons for the address, such as, for example: “please come see me,” or “please contact me,” or “I need something,” or the like. In some implementations, an application running on an associated computing device of each of the first person and the potential second persons can provide a set of icons in a menu, where each icon represents an urgency and/or reason for the address. The icons can be displayed next to the identity of each of the potential second persons listed in the menu. The menu can be a drop-down menu accessible by clicking on an application icon or graphic, which in turn can be displayed in a control bar or control area of a graphical user interface.

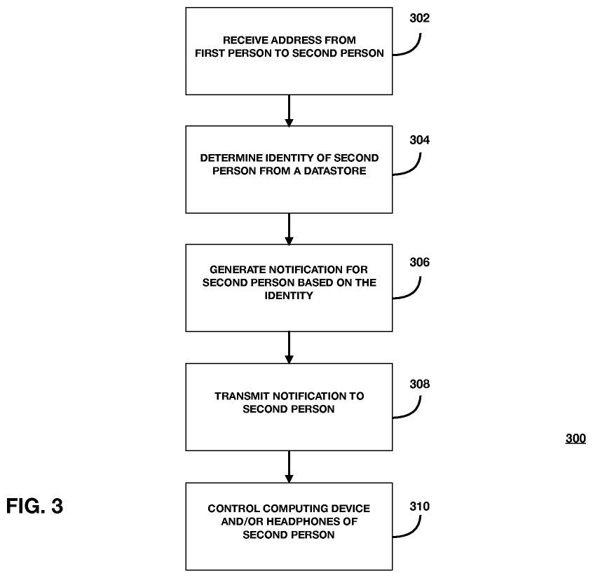

FIG. 3 is a flowchart of a method 300 for point-to-point communication in a shared environment. At 302, a computing or communication system receives an address from a first person to a second person, within an environment the second person may or may not share with other persons. The address can be an audible address, such as the first person verbally calling out or speaking into a microphone the second person's name or other identifying information. Alternatively, the address can be an input to the computing or communication system by the first person, such as a selection of the second person from a list of potential second persons within the shared environment.

At 304, the computing or communication system determines an identity of the second person being addressed. The determining can include a lookup of the identity, based in part on the address, from a datastore. In some implementations, the lookup to the datastore can occur after the address is received and processed to determine data representing the identity of the targeted second person. The processing can include NLP and A for determining the data representing the identity of the second person.

At 306, a notification is generated based on the identity of the second person as determined at 304. The notification can include a user identifier (UID) of the second person, which an application executed by the computing or communication system can employ to properly direct the notification to the desired second person. The notification can also include, in metadata or other data, such as input data, a representation of the address, which can further include one or both of an urgency and a reason for the address.

At 308, the notification is transmitted via the computing or communication system to a computing system associated with the target second person. The computing or communication system can be communicatively coupled with the second person's computing system via a communication network, which can include wired communication channels and/or wireless communication channels. The transmitting can be by encrypted text or encoded data. For example, a selection of an address by the first person can be mapped to a simple code that is transmitted in near-real-time, and which code is decoded at the computing system of the second person, which displays, renders or plays an audible or visual representation of the selected address for the target second person.

At 310, once the notification of the address is received at and/or acknowledged by the computing system of the target second person, a computing device and/or headphones being used by the target second person is controlled to display, render or play the audible or visual representation of the address sent or selected by the first person. In some instances, the display of the address can be a simple pop-up window in a display of the computing device with a representation of the address. In other cases, the computing system controls the headphones of the second person, such as attenuates or eliminates any sound produced by the headphones, or alternatively generates a unique sound that is overlaid on or intermixed with any sound produced by the headphones. Such display, rendering or playing will therefore alert the target second person to the address, enabling the target second person to respond, and all without bothering or interrupting any other persons within the shared environment. In some instances, the target second person can include one or more actual persons within the shared environment. Further, the shared environment can be an actual, physical environment, or a virtual environment.

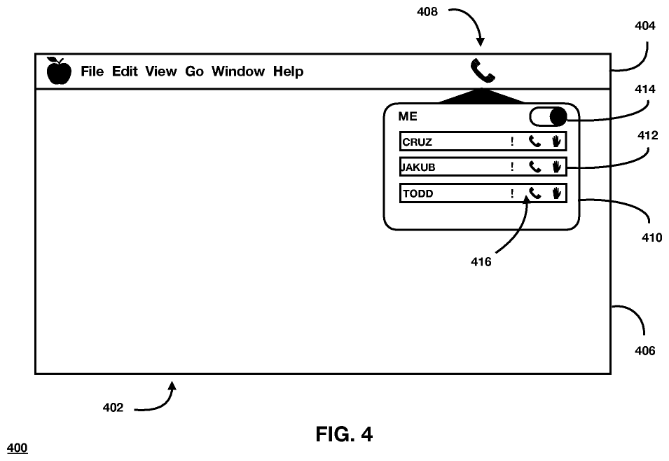

FIG. 4 illustrates an application display 400 that generates a graphical user interface (GUI) 402. The GUI 402 includes a control bar 404, or control area of the GUI 402. The control bar 404 can include various commands as text or icons, which when selected can generate or produce a pull-down menu of subcommands or other control instructions or features, or otherwise execute a command as represented by the text or icon. The GUI 402 further includes an active region 406, or work region, which can be configured to display the user interface of one or more active applications, such as a web browser, a word processor, a dating application, a spreadsheet application, or other specialized application. The active application being displayed in the active region can influence, or otherwise be associated with or related to, the commands displayed in the control bar 404.

In some implementations, such as described in the instant disclosure, the control bar 404 can include a special control 408 or icon that controls execution of an application for point-to-point communication in a shared environment. The special control 408 can be a unique icon to represent the application for point-to-point communication, or it may represent the shared environment for enabling point-to-point communication therein. Upon selection of the special control 408 (i.e. by a user clicking on it with a mouse or trackpad, or the like, via a graphical cursor rendered within the GUI 402), a pop-up (or pop-down) application window 410 can be generated, preferably for display within the active region 406 of the GUI 402.

The application window 410 can display information that at least a first person can access to effectuate an address one or more target second persons. For instance, the application window 410 can display a list of registered users 412, where each registered user 412 is an occupant, virtually or physically, of a shared environment with other registered users 412. In accordance with some implementations, each person of the shared environment can register themselves as a registered user 412, by supplying identifying information such as a name, email address, user ID, or the like, and acknowledging a willingness to be contacted by a first person via the application.

The application window 410 can further include one or more user controls 414, such as ON/OFF switches or the like, for allowing a first person user to control how and when the application can be used, particularly in reference to the list of potential target second persons as indicated by the list of registered users 412.

In operation, a first person can click on the icon 408, which generates the pop-up window 410, which in turn displays a list of registered users 412 that represents potential target second persons. The first person can click on a selected single, or two or more, registered users 412, which action generates a notification for the selected registered user(s) to be sent by the application via a communication network to each of the selected registered user(s), that the first person is addressing the selected registered users (i.e. second person(s)) and wants to interface with the selected second person in some way. In some implementations, a graphical representation of each registered user 412 can include one or more action icons 416. Each action icon 416 can represent an action, urgency, or reason associated with the address of the second person(s), which can be transmitted along with the address and displayed by the application on the target second person's computing system, so as to communicate such action, urgency or reason for the address, all the while not disturbing or distracting other users or persons within the shared environment.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
receiving an address from a first person to a second person, the second person using a computing system that provides at least limited aural or visual isolation for the second person within a shared environment;
determining an identity of the second person from a datastore according to the address from the first person, the identity being associated with a computing system used by the second person; and
generating a notification for the second person based on determining the identity, the notification comprising an electronic signal that is transmittable via a communication network to the computing device associated with the second person.

2. The computer program product in accordance with claim 1, wherein the electronic signal of the notification further includes an instruction for modifying the sound generated by the headphones after the identity of the second person is determined, so as to inhibit the at least limited aural isolation by the headphones within the shared environment.

3. The computer program product in accordance with claim 2, wherein the instruction for modifying incudes an instruction for attenuating the sound generated by the headphones.

4. The computer program product in accordance with claim 1, wherein the electronic signal of the notification further includes an instruction for generating an alert on the computing device associated with the second person.

5. The computer program product in accordance with claim 4, wherein the alert comprises a graphical representation generated by the computing device of the address.

6. The computer program product in accordance with claim 1, wherein the address includes a verbal address by the first person that is received by a microphone associated with the headphones of the second person.

7. The computer program product in accordance with claim 6, wherein determining the identity of the second person further includes:
executing a natural language algorithm on the address received by the microphone to determine an identifier associated with the second person; and
performing a lookup on the datastore based on the identifier to determine the identity of the second person.

8. A computer-implemented method comprising:
receiving an address from a first person to a second person, the second person using headphones that produce sound to provide at least limited aural isolation for the second person within a shared environment;
determining an identity of the second person from a datastore according to the address from the first person, the identity being associated with the headphones used by the second person; and
generating a notification for the second person based on determining the identity, the notification comprising an electronic signal that is transmittable via a communication network to a computing device associated with the second person.

9. The computer-implemented method in accordance with claim 8, wherein the electronic signal of the notification further includes an instruction for modifying the sound generated by the headphones after the identity of the second person is determined, so as to inhibit the at least limited aural isolation by the headphones within the shared environment

10. The computer-implemented method in accordance with claim 9, wherein the instruction for modifying incudes an instruction for attenuating the sound generated by the headphones.

11. The computer-implemented method in accordance with claim 8, wherein the electronic signal of the notification further includes an instruction for generating an alert on the computing device associated with the second person.

12. The computer-implemented method in accordance with claim 11, wherein the alert comprises a graphical representation of the address generated by the computing device.

13. The computer-implemented method in accordance with claim 8, wherein the address includes a verbal address by the first person that is received by a microphone associated with the headphones of the second person.

14. The computer-implemented method in accordance with claim 6, wherein determining the identity of the second person further includes:
executing a natural language algorithm on the address received by the microphone to determine an identifier associated with the second person; and
performing a lookup on the datastore based on the identifier to determine the identity of the second person.

15. A system comprising:
a plurality of computers, each computer of the plurality of computers having an operating system that provides one or more services for operating the computer, the one or more services including a communication service for using headphones in a shared environment, the communication service being configured for:
receiving an address from a first person to a second person, the second person using headphones that produce sound to provide at least limited aural isolation for the second person within a shared environment;
determining an identity of the second person from a datastore according to the address from the first person, the identity being associated with the headphones used by the second person; and
generating a notification for the second person based on determining the identity, the notification comprising an electronic signal that is transmittable via a communication network to a computing device associated with the second person.

16. The system in accordance with claim 15, wherein the electronic signal of the notification further includes an instruction for modifying the sound generated by the headphones after the identity of the second person is determined, so as to inhibit the at least limited aural isolation by the headphones within the shared environment.

17. The system in accordance with claim 16, wherein the instruction for modifying incudes an instruction for attenuating the sound generated by the headphones.

18. The system in accordance with claim 15, wherein the electronic signal of the notification further includes an instruction for generating an alert on the computing device associated with the second person.

19. The system in accordance with claim 18, wherein the alert comprises a graphical representation generated by the computing device of the address.

20. The system in accordance with claim 15, wherein the address includes a verbal address by the first person that is received by a microphone associated with the headphones of the second person.

21. The system in accordance with claim 20, wherein determining the identity of the second person further includes:
executing a natural language algorithm on the address received by the microphone to determine an identifier associated with the second person; and
performing a lookup on the datastore based on the identifier to determine the identity of the second person.
